(19) United States
(12) Patent Application Publication
(10) Pub. No.: US 2026/0220101 A1
(43) Pub. Date: Jul. 30, 2026

(54) RECORD PAIR IDENTITY OUTPUT APPARATUS, PARAMETER GENERATION APPARATUS, RECORD PAIR IDENTITY OUTPUT METHOD, AND STORAGE MEDIUM

(71) Applicant: NEC Corporation, Minato-ku, Tokyo (JP)

(72) Inventors: Shogo HAYASHI, Tokyo (JP); Genki KUSANO, Tokyo (JP); Masafumi OYAMADA, Tokyo (JP)

(73) Assignee: NEC Corporation, Minato-ku, Tokyo (JP)

(21) Appl. No.: 18/724,285

(22) PCT Filed: Jan. 6, 2022
(86) PCT No.: PCT/JP2022/000215

§ 371 Date: Jun. 26, 2024

(51) Int. Cl. G06F 16/215; G06F 16/248

(52) U.S. Cl. CPC G06F 16/215; G06F 16/248

(57) ABSTRACT

In order to more suitably predict identity between a record pair, an information processing apparatus (1) includes: an acquisition means (11) that acquires a record pair; a similarity calculation means (12) that uses a plurality of similarity functions to calculate a plurality of similarities for the record pair; a prediction means (13) that refers to the record pair and the plurality of similarities and that uses an importance level determined in accordance with the record pair to carry out identity prediction with respect to the record pair; and an output means (14) that outputs a prediction result from the prediction means (13).

### TECHNICAL FIELD

The present invention relates to a technique for carrying out identity prediction with respect to a record pair.

### BACKGROUND ART

A process is carried out in which combinations of identical or similar records are specified from records stored in different tables, and are associated with each other. Such a process is also referred to as a merging process. The merging process enables integrated management of tables and data augmentation. As a technique for carrying out the merging process, there is a technique for carrying out machine learning or rule-based matching. For example, Patent Literature 1 and Non-patent Literature 1 each disclose a technique for carrying out the merging process by machine learning. In particular, a merging processing apparatus disclosed in Patent Literature 1 includes an information processing apparatus, a storage section, and an operation terminal. The merging processing apparatus calculates a similarity between a record pair with use of a plurality of similarity functions for calculating the similarity between the record pair, and learns, by machine learning in which training data is used, a weight for calculating the similarity.

### CITATION LIST

### Patent Literature

### Patent Literature 1

Japanese Patent Application Publication Tokukai No. 2019-185244

### Non-Patent Literature

### Non-patent Literature 1

Pradap Konda, et. al., Magellan: Toward Building Entity Matching Management Systems, Proceedings of the VLDB Endowment, 2016

### SUMMARY OF INVENTION

### Technical Problem

There are various methods as a method for determining identity between a record pair. For example, identity between a record pair of “aisu [ice] (written in katakana)” and “aisu (written in hiragana)” can be determined with higher accuracy by changing katakana notation to hiragana notation. Further, identity between a record pair of “potato chips” and “potechi” (a Japanese abbreviation of “potato chips”) can be determined with higher accuracy by extracting a partial character string. A method suitable for determining identity between a record pair thus may vary from record pair to record pair. The techniques disclosed in Patent Literature 1 and Non-patent Literature 1 have a problem in that identity determination cannot be suitably carried out depending on a record pair.

An example aspect of the present invention has been made in view of the above problem, and an example object thereof is to provide a technique that makes it possible to more suitably predict identity between a record pair.

### Solution to Problem

An information processing apparatus according to an example aspect of the present invention includes: an acquisition means that acquires a record pair; a similarity calculation means that uses a plurality of similarity functions to calculate a plurality of similarities for the record pair; a prediction means that refers to the record pair and the plurality of similarities and that uses an importance level determined in accordance with the record pair to carry out identity prediction with respect to the record pair; and an output means that outputs a prediction result from the prediction means.

An information processing apparatus according to an example aspect of the present invention includes: an acquisition means that acquires training data including a plurality of sets of a record pair and a label regarding identity between the record pair; and a parameter generation means that generates, with reference to the training data, at least one parameter selected from the group consisting of one or more parameters that are possessed by each of a plurality of similarity functions for calculating a plurality of similarities for a record pair to be subjected to prediction, and one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

An information processing method according to an example aspect of the present invention includes: acquiring a record pair; using a plurality of similarity functions to calculate a plurality of similarities for the record pair; referring to the record pair and the plurality of similarities, and using an importance level determined in accordance with the record pair to carry out identity prediction with respect to the record pair; and outputting a prediction result obtained by the identity prediction carried out with respect to the record pair.

An information processing method according to an example aspect of the present invention includes: acquiring training data including a plurality of sets of a record pair and a label regarding identity between the record pair; and generating, with reference to the training data, at least one parameter selected from the group consisting of one or more parameters that are possessed by each of a plurality of similarity functions for calculating a plurality of similarities for a record pair to be subjected to prediction, and one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

A production method according to an example aspect of the present invention includes: acquiring training data including a plurality of sets of a record pair and a label regarding identity between the record pair; and generating, with reference to the training data, at least one model selected from the group consisting of a plurality of similarity calculation models for calculating a plurality of similarities for a record pair to be subjected to prediction, and an importance level calculation model used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

A program according to an example aspect of the present invention causes a computer to carry out: an acquisition process for acquiring a record pair; a similarity calculation process for using a plurality of similarity functions to calculate a plurality of similarities for the record pair; a prediction process for referring to the record pair and the plurality of similarities, and using an importance level determined in accordance with the record pair to carry out identity prediction with respect to the record pair; and an output process for outputting a prediction result obtained by the prediction process.

A program according to an example aspect of the present invention causes a computer to carry out: an acquisition process for acquiring training data including a plurality of sets of a record pair and a label regarding identity between the record pair; and a parameter generation process for generating, with reference to the training data, at least one parameter selected from the group consisting of one or more parameters that are possessed by each of a plurality of similarity functions for calculating a plurality of similarities for a record pair to be subjected to prediction, and one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

### Advantageous Effects of Invention

An aspect of the present invention makes it possible to more suitably predict identity between a record pair.

### BRIEF DESCRIPTION OF DRAWINGS

FIG. 1 is a block diagram illustrating a configuration of an information processing apparatus according to a first example embodiment.

FIG. 2 is a flowchart showing a flow of an information processing method according to the first example embodiment.

FIG. 3 is a block diagram illustrating a configuration of an information processing apparatus according to the first example embodiment.

FIG. 4 is a flowchart showing a flow of an information processing method according to the first example embodiment.

FIG. 5 is a block diagram illustrating a configuration of an information processing apparatus according to a second example embodiment.

FIG. 6 is a diagram illustrating a specific example of first data and second data according to the second example embodiment.

FIG. 7 is a flowchart showing a flow of an information processing method according to the second example embodiment.

FIG. 8 is a diagram illustrating a specific example of integrated data according to the second example embodiment.

FIG. 9 is a block diagram illustrating a configuration of an information processing apparatus according to a third example embodiment.

FIG. 10 is a flowchart showing a flow of an information processing method according to the third example embodiment.

FIG. 11 is a block diagram illustrating a configuration of an information processing apparatus according to a fourth example embodiment.

FIG. 12 is a diagram illustrating an example screen display according to the fourth example embodiment.

FIG. 13 is a block diagram illustrating a configuration of a computer functioning as each of information processing apparatuses according to the example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for example embodiments described later.

### <Configuration of Information Processing Apparatus 1>

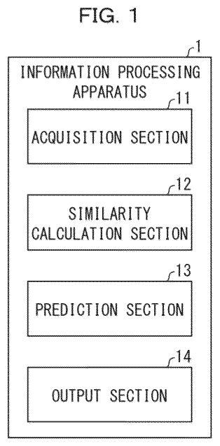

The following description will discuss a configuration of an information processing apparatus 1 according to the present example embodiment with reference to FIG. 1. FIG. 1 is a block diagram illustrating the configuration of the information processing apparatus 1. The information processing apparatus 1 is an apparatus that carries out identity prediction with respect to a record pair. The information processing apparatus 1 includes an acquisition section 11, a similarity calculation section 12, a prediction section 13, and an output section 14.

### (Acquisition Section 11)

The acquisition section 11 acquires a record pair.

### (Record Pair and Record)

A record pair is a set of a plurality of records. For example, a record is a row of a table, and includes a set of one or more attribute names and attribute values corresponding to a column of the table. The number of records included in the record pair may be two, or three or more. The record pair is, for example, a set of a record included in a first table and a record included in a second table. The first table and the second table are each, for example, a table in which customer information of a business operator is stored, or a table in which product information is stored. Note, however, that the first table and the second table are not limited to the above-described example, and each may be another table. Note also that the first table and the second table may be identical to or different from each other.

### (Similarity Calculation Section 12)

The similarity calculation section 12 uses a plurality of similarity functions to calculate a plurality of similarities for the record pair acquired by the acquisition section 11. In other words, the similarity calculation section 12 uses k (k is an integer of not less than 2) similarity functions φᵢ (1≤i≤k) to calculate k similarities for one record pair.

### (Similarity Function)

A similarity function φᵢ is a function for calculating a similarity between records included in the record pair. Hereinafter, the similarity function φᵢ is also referred to as a “similarity calculation model”. An input to the similarity function φᵢ is a record pair, and an output from the similarity function φᵢ is a similarity between records included in the record pair. A plurality of similarity functions φᵢ can be subjected to training by an information processing apparatus 2 described later. In a case where a similarity function φᵢ is generated by machine learning, a method for machine learning of the similarity function φᵢ is not limited. For example, a decision tree-based method, a method using linear regression, or a method using a neural network may be used. Alternatively, two or more of these methods may be used. Examples of the decision tree-based method include Light Gradient Boosting Machine (LightGBM), Random Forest, and XGBoost. Examples of the linear regression include Bayesian regression, support vector regression, Ridge regression, Lasso regression, and ElasticNet. Examples of the neural network include deep learning.

The similarity function φᵢ outputs, for example, a numerical value of 0 to 1 as a similarity. For example, a Jaccard coefficient can be used for the similarity function φᵢ. The Jaccard coefficient is used to calculate |A∩B|/|A∪B| for a set A={a1, a2, . . . } and a set B={b1, b2, . . . }. Further, for example, a method disclosed in Non-patent Literature 1 may be used for the similarity function φᵢ. Alternatively, as another example, a method described in, for example, a document “Yuliang Li, Jinfeng Li, Yoshihiko Suhara, AnHai Doan, Wang-Chiew Tan, Deep Entity Matching with Pre-Trained Language Models, Proceedings of the VLDB Endowment, 2016” (hereinafter referred to as “Non-Patent Literature 2”) may be used for the similarity function φᵢ. Note, however, that the similarity function φᵢ is not limited to the above-described example, and another method may be used for the similarity function φᵢ to calculate a similarity between a record pair.

### (Prediction Section 13)

The prediction section 13 refers to the record pair and the plurality of similarities, and uses an importance level determined in accordance with the record pair to carry out identity prediction with respect to the record pair.

### (Importance Level)

The importance level is information determined in accordance with the record pair. For example, the importance level is calculated with reference to the record pair. More specifically, for example, the prediction section 13 uses an importance level calculation model for calculating an importance level to calculate the importance level. In this case, an input to the importance level calculation model is the record pair. Further, an output from the importance level calculation model is the importance level. The importance level calculation model can be subjected to training by the information processing apparatus 2 described later. In a case where the importance level calculation model is generated by machine learning, a method for machine learning of the importance level calculation model is not limited. For example, a decision tree-based method, a method using linear regression, or a method using a neural network may be used. Alternatively, two or more of these methods may be used.

For example, a language model such as Bidirectional Encoder Representations from Transformers (BERT), fastText, word2vec, tf-idf, or BM25 is used to generate the importance level calculation model. Further, the importance level calculation model may include the language model. The following description will discuss a specific example of an importance level calculation process carried out in a case where the language model is used. For example, the prediction section 13 uses the language model to transform the record pair into a vector, and transforms the vector into a vector in still another feature space. Further, the prediction section 13 calculates k importance levels by inputting the vector to a k-class classifier (softmax function, etc.). The calculated k importance levels correspond to respective the k similarity functions φᵢ.

Note, however, that a method for calculating the importance level is not limited to the above-described example. The prediction section 13 may calculate the importance level by another method. For example, the prediction section 13 may calculate the importance level by a rule-based process. For example, the prediction section 13 may calculate the importance level by referring to a table in which the importance level is associated with information pertaining to the record pair. Note here that the information pertaining to the record pair may include, for example, feature values of records included in the record pair, a result of classification of the records, or names of the records.

For example, the prediction section 13 carries out identity prediction with respect to the record pair with use of a linear sum regarding the plurality of similarities calculated by the similarity calculation section 12, the linear sum using, as a weighting factor, the importance level regarding each of the similarities. Note, however, that a method in which the prediction section 13 carries out identity prediction is not limited to a method in which a linear sum is used. The prediction section 13 may carry out identity prediction with respect to the record pair by another method.

For example, the prediction section 13 may carry out identity prediction with respect to the record pair by inputting the record pair and a similarity to a prediction model generated by machine learning. In this case, an input to the prediction model includes, for example, a set of k similarities and the record pair. An output from the prediction model includes, for example, a prediction result for identity. Further, the prediction section 13 calculates, as the importance level, a parameter possessed by the prediction model. A method for machine learning of the prediction model is not limited. For example, a decision tree-based method, a method using linear regression, or a method using a neural network may be used. Alternatively, two or more of these methods may be used.

### (Output Section 14)

The output section 14 outputs a prediction result from the prediction section 13. The prediction result includes, for example, information indicating whether records included in the record pair are identical or information indicating a similarity between the records included in the record pair.

The prediction result from the prediction section 13 is used in, for example, a table integration process or an information retrieval process. In a case where tables are integrated, linking the records predicted by the prediction section 13 to be identical makes it possible to integrate a plurality of tables and achieve integrated management of data. Further, in information retrieval, the prediction section 13 may carry out identity prediction with respect to a record pair of a record (e.g., a record specified by a user) serving as a search key and any other record registered in a predetermined table. In this case, the information processing apparatus 1 may output, as a search result, records included in the record pair and predicted by the prediction section 13 to be identical. This makes it possible to carry out a search process in a table that is not linked with the record serving as the search key.

### <Effect of Information Processing Apparatus 1>

As described above, in the information processing apparatus 1 according to the present example embodiment, a configuration is employed such that a plurality of similarity functions are used to calculate a plurality of similarities for a record pair, the record pair and the plurality of similarities are referred to, and an importance level determined in accordance with the record pair is used to carry out identity prediction with respect to the record pair. Note here that, since the importance level is determined in accordance with the record pair, a result of identity prediction based on the plurality of similarities is not obtained by a uniform method, and an importance level for each record pair is reflected in the result. Thus, the information processing apparatus 1 according to the present example embodiment brings about an effect of making it possible to more suitably predict identity between a record pair.

### <Flow of Information Processing Method S1>

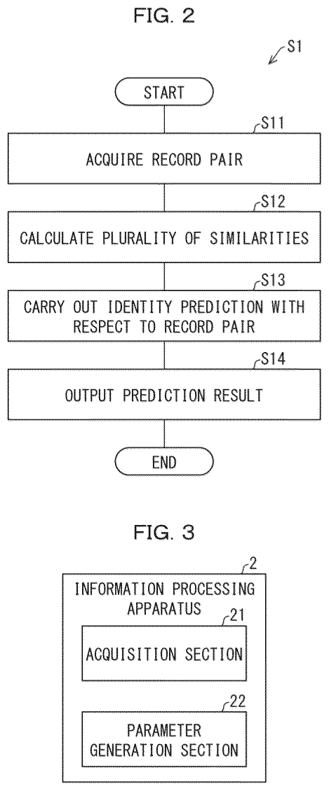

The following description will discuss a flow of an information processing method S1 according to the present example embodiment with reference to FIG. 2. FIG. 2 is a flowchart illustrating the flow of the information processing method S1. In step S11, the acquisition section 11 acquires a record pair. In step S12, the similarity calculation section 12 uses a plurality of similarity functions to calculate a plurality of similarities for the record pair. In step S13, the prediction section 13 refers to the record pair and the plurality of similarities, and uses an importance level determined in accordance with the record pair to carry out identity prediction with respect to the record pair. In step S14, the output section 14 outputs a prediction result from the prediction section 13.

### <Effect of Information Processing Method S1>

As described above, in the information processing method S1 according to the present example embodiment, a configuration is employed such that a plurality of similarity functions are used to calculate a plurality of similarities for a record pair, the record pair and the plurality of similarities are referred to, and an importance level determined in accordance with the record pair is used to carry out identity prediction with respect to the record pair. Thus, the information processing method S1 according to the present example embodiment brings about an effect of making it possible to more suitably predict identity between a record pair.

### <Configuration of Information Processing Apparatus 2>

Next, the following description will discuss a configuration of an information processing apparatus 2 according to the present example embodiment with reference to FIG. 3. FIG. 3 is a block diagram illustrating the configuration of the information processing apparatus 2. The information processing apparatus 2 is an apparatus that generates a parameter which is used to predict identity between a record pair. The information processing apparatus 2 includes an acquisition section 21 and a parameter generation section 22.

The acquisition section 21 acquires training data including a plurality of sets of a record pair and a label regarding identity between the record pair. The label regarding identity indicates, for example, whether records included in the record pair are identical.

The parameter generation section 22 generates, with reference to the training data, at least one parameter selected from the group consisting of (i) one or more parameters that are possessed by each of a plurality of similarity functions φᵢ for calculating a plurality of similarities for a record pair to be subjected to prediction, and (ii) one or more parameters that are possessed by an importance level calculation model which is used by the prediction section 13 to calculate an importance level determined in accordance with the record pair to be subjected to prediction, the prediction section 13 referring to the record pair to be subjected to prediction and the plurality of similarities, and using the importance level to carry out identity prediction with respect to the record pair to be subjected to prediction.

### <Effect of Information Processing Apparatus 2>

As described above, in the information processing apparatus 2 according to the present example embodiment, a configuration is employed such that: training data including a plurality of sets of a record pair and a label regarding identity between the record pair is acquired; and at least one parameter selected from the group consisting of one or more parameters that are possessed by each of a plurality of similarity functions for calculating a plurality of similarities for a record pair to be subjected to prediction, and one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction, is generated with reference to the training data. Thus, the information processing apparatus 2 according to the present example embodiment brings about an effect of making it possible to generate a parameter that makes it possible to more suitably predict identity between a record pair.

### <Flow of Information Processing Method S2>

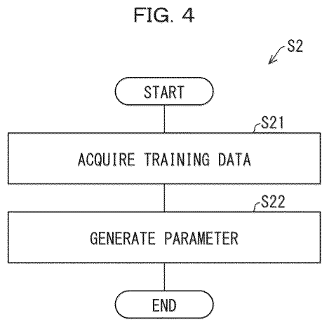

The following description will discuss a flow of an information processing method S2 according to the present example embodiment with reference to FIG. 4. FIG. 4 is a flowchart illustrating the flow of the information processing method S2. In step S21, the acquisition section 21 acquires training data including a plurality of sets of a record pair and a label regarding identity between the record pair. In step S22, the parameter generation section 22 generates, with reference to the training data, at least one parameter selected from the group consisting of (i) one or more parameters that are possessed by each of a plurality of similarity functions for calculating a plurality of similarities for a record pair to be subjected to prediction, and (ii) one or more parameters that are possessed by an importance level calculation model which is used by the prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

### <Effect of Information Processing Method S2>

As described above, in the information processing method S2 according to the present example embodiment, a configuration is employed such that: training data including a plurality of sets of a record pair and a label regarding identity between the record pair is acquired; and at least one parameter selected from the group consisting of one or more parameters that are possessed by each of a plurality of similarity functions for calculating a plurality of similarities for a record pair to be subjected to prediction, and one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction, is generated with reference to the training data. Thus, the information processing method S2 according to the present example embodiment brings about an effect of making it possible to generate a parameter that makes it possible to more suitably predict identity between a record pair.

### <Production Method>

The information processing apparatus 2 can be specified as an apparatus that carries out a method for producing a trained model. Note here that the method for producing a trained model includes: acquiring training data including a plurality of sets of a record pair and a label regarding identity between the record pair; and generating, with reference to the training data, at least one model selected from the group consisting of a plurality of similarity calculation models and an importance level calculation model.

### Second Example Embodiment

The following will discuss a second example embodiment of the present invention in detail with reference to drawings. Note that members having functions identical to those of the respective members described in the first example embodiment are given respective identical reference numerals, and a description of those members is not repeated.

### <Configuration of Information Processing Apparatus 1A>

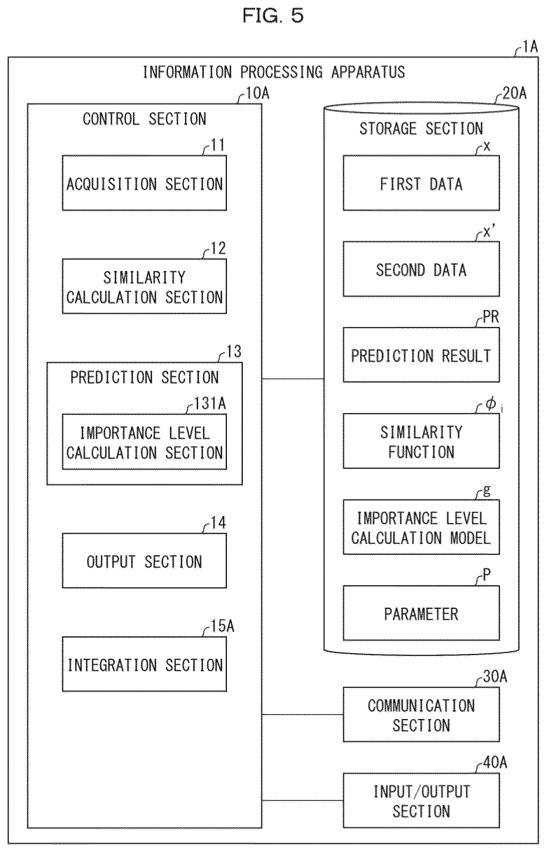

FIG. 5 is a block diagram illustrating a configuration of an information processing apparatus 1A according to the present example embodiment. The information processing apparatus 1A includes a control section 10A, a storage section 20A, a communication section 30A, and an input/output section 40A.

### (Communication Section 30A)

The communication section 30A communicates, via a communication line, with an apparatus external to the information processing apparatus 1A. A specific configuration of the communication line is not limited to the present example embodiment. Examples of the communication line include a wireless local area network (LAN), a wired LAN, a wide area network (WAN), a public network, a mobile data communication network, and a combination thereof. The communication section 30A transmits, to another apparatus, data supplied from the control section 10A, and supplies, to the control section 10A, data received from another apparatus.

### (Input/Output Section 40A)

To the input/output section 40A, an input/output apparatus(es) such as a keyboard, a mouse, a display, a printer, and/or a touch panel is/are connected. The input/output section 40A receives, from an input apparatus(es) connected thereto, an input of various pieces of information to the information processing apparatus 1A. The input/output section 40A outputs, to an output apparatus(es) connected thereto, various pieces of information under control by the control section 10A. Examples of the input/output section 40A include an interface such as a universal serial bus (USB).

### (Control Section 10A)

The control section 10A includes an acquisition section 11, a similarity calculation section 12, a prediction section 13, an output section 14, and an integration section 15A as illustrated in FIG. 5.

### (Acquisition Section 11)

The acquisition section 11 acquires first data x including a first record e included in the record pair and second data x′ including a second record e′ included in the record pair. The first data x and the second data x′ are, for example, tables including a plurality of records. The first record e□x and the second record e′□x′ are, for example, expressed as follows.

$$e = ( {a}_{1} : {v}_{1} , {a}_{2} : {v}_{2} , … , {a}_{d} : {v}_{d} ) \\ {e}^{′} = ( {a}_{1} : {v}_{1} , {a}_{2} : {v}_{2} , … , {a}_{{d}^{′}} : {v}_{{d}^{′}}^{′} )$$

where: a₁□A₁ (1=1, 2, . . . d) and a′ₘ□A′ₘ (m=1, 2, . . . d′) are attribute names; A₁ and A′ₘ are, for example, character string spaces; v₁□V₁ and v′ₘ□V′ₘ are attribute values; V₁ and V′ₘ are, for example, character string spaces or real number spaces; d is the number attributes possessed by the record e; and d′ is the number of attributes possessed by the record e′. In other words, the first record e and the second record e′ each include a plurality of sets of an attribute name and an attribute value.

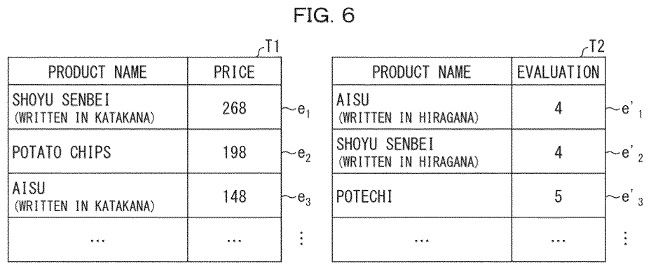

FIG. 6 is a diagram illustrating a table T1 and a table T2 that are specific examples of the first data x and the second data x′. The table T1 and the table T2 are each composed of rows and columns. A row corresponds to a record, and a column corresponds to an attribute. In other words, the table T1 includes a plurality of first records e₁, e₂, . . . . The table T2 includes a plurality of second records e′₁, e′₂, . . . .

The first record e₂ in FIG. 6 is expressed as e₂=(product name: potato chips, price: 198). In the first record e₂, an attribute value of an attribute whose attribute name is “product name” is “potato chips”, and an attribute value of an attribute whose attribute name is “price” is “198”.

An attribute name and an attribute value in the table T1 may be identical to or different from an attribute name and an attribute value in the table T2. In the example of FIG. 6, a record pair (e, e′) acquired by the acquisition section 11 is a pair of any one of the first records e₁, e₂, . . . included in the table T1 and any one of the second records e′₁, e′₂, . . . included in the table T2.

### (Similarity Calculation Section 12)

The similarity calculation section 12 uses k (k is an integer of not less than 2) similarity functions φᵢ (1≤i≤k) to calculate k similarities sᵢ for one record pair (e, e′). A process in which the similarity calculation section 12 calculates the k similarities sᵢ will be described later in detail.

### (Prediction Section 13)

The prediction section 13 refers to the record pair (e, e′) and the plurality of similarities sᵢ, and uses an importance level determined in accordance with the record pair (e, e′) to carry out identity prediction with respect to the record pair. In the present example embodiment, the prediction section 13 includes an importance level calculation section 131A that calculates the importance level with reference to the record pair (e, e′). An identity prediction process carried out by the prediction section 13 and an importance level calculation process carried out by the importance level calculation section 131A will be described later in detail.

### (Output Section 14)

The output section 14 outputs a prediction result from the prediction section 13. The prediction result includes, for example, information indicating whether records included in the record pair are identical. Further, the prediction result may include information indicating a degree of similarity between the records included in the record pair. The output section 14 may output the prediction result by writing the prediction result to the storage section 20A or an external storage apparatus, or may output the prediction result to an output apparatus(es) (a display apparatus, a printing apparatus, and/or the like) connected to the input/output section 40A. Alternatively, the output section 14 may output the prediction result by transmitting the prediction result to another apparatus via the communication section 30A.

### (Integration Section 15A)

The integration section 15A generates integrated data from first data and second data with reference to the prediction result output by the output section 14. An integrated data generation process carried out by the integration section 15A will be described later in detail.

### (Storage Section 20A)

In the storage section 20A, the first data x and the second data x′ that are acquired by the acquisition section 11 are stored, and a prediction result PR from the prediction section 13 is stored. Further, a plurality of similarity functions φᵢ, an importance level calculation model g, and a parameter P are stored in the storage section 20A.

As shown in the above-described first example embodiment, similarity functions {φ₁, . . . , φₖ} are functions for calculating a similarity by, for example, a Jaccard coefficient, or the method disclosed in Non-patent Literature 1 or Non-Patent Literature 2. A similarity function φᵢ is input by, for example, a user of the information processing apparatus 1A. For example, the similarity function φᵢ outputs, to the record pair (e, e′), a numerical value of 0 to 1 as a similarity. In this case, for example, an output value that is closer is to 1 means a higher similarity, and an output value that is closer to 0 means a lower the similarity. The similarity function φᵢ is, for example, a function including a trainable parameter.

The importance level calculation model g is a model used by the importance level calculation section 131A to calculate the importance level. As shown in the above-described first example embodiment, for example, a language model such as BERT, fastText, word2vec, tf-idf, or BM25 is used to generate the importance level calculation model g. Further, the importance level calculation model g may include the language model.

The parameter P stored in the storage section 20A includes at least one parameter selected from the group consisting of one or more parameters θᵢ possessed by each of k similarity functions φᵢ, and one or more parameters w possessed by the importance level calculation model g.

### <Flow of Information Processing Method S1A>

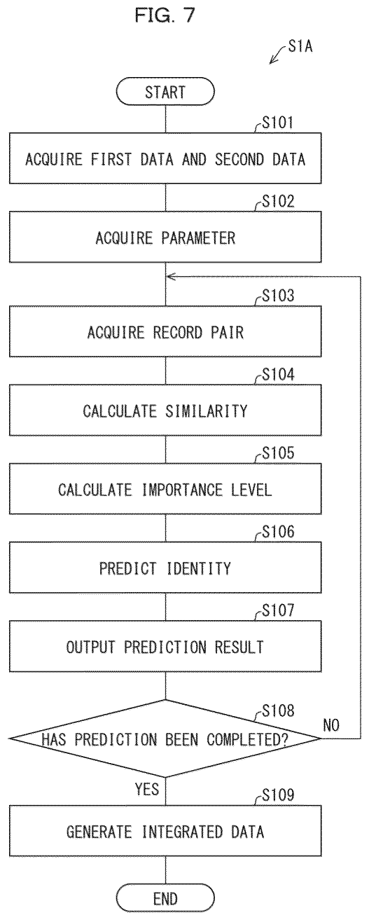

FIG. 7 is a flowchart showing a flow of an information processing method S1A that is an example of an information processing method carried out by the information processing apparatus 1A. Note that some of steps may be carried out in parallel or in a different order. Note also that a description of the content already described is not repeated.

### (Step S101)

In step S101, the acquisition section 11 acquires the first data and the second data. The acquisition section 11 acquires, for example, first data and second data that are input by, for example, a user of the information processing apparatus 1A with use of an input apparatus connected to the input/output section 40A. Alternatively, the acquisition section 11 may acquire the first data and the second data by receiving the first data and the second data from another apparatus via the communication section 30A. Further alternatively, the acquisition section 11 may acquire the first data and the second data by reading the first data and the second data from an externally connected storage apparatus. The acquisition section 11 stores the acquired first data and the acquired second data in the storage section 20A.

### (Step S102)

In step S102, the acquisition section 11 acquires the parameter P stored in the storage section 20A.

### (Step S103)

In step S103, the acquisition section 11 acquires the record pair (e, e′) to be subjected to prediction.

### (Step S104)

In step S104, the similarity calculation section 12 uses the k similarity functions φᵢ to calculate the k similarities sᵢ for the record pair (e, e′). Since the k similarity functions φᵢ are different from each other, values of the calculated k similarities sᵢ can also be different from each other. For example, in the case of a record pair of “aisu (written in katakana)” and “aisu (written in hiragana)”, a similarity sᵢ calculated by carrying out notation change has a value indicating a high similarity, whereas the similarity sᵢ calculated by extracting a partial character string has a value indicating a low similarity. Further, in the case of a record pair of “potato chips” and “potechi”, the similarity sᵢ calculated by carrying out notation change has a value indicating a low similarity, whereas the similarity sᵢ calculated by extracting a partial character string has a value indicating a high similarity.

### (Step S105)

In step S105, the importance level calculation section 131A refers to the record pair (e, e′) and calculates an importance level gᵢ regarding each of the plurality of similarities sᵢ. For example, the importance level calculation section 131A uses the importance level calculation model g to calculate the importance level gᵢ.

The importance level calculation model g is a model for calculating the importance level gᵢ for each of the plurality of similarities sᵢ. For example, the importance level calculation model g is expressed as follows:

$$g : X \times {X}^{′} \to {[ 0 , 1 ]}^{k} , {\sum }_{i = 1}^{k} {\{ g ( e , {e}^{′} ) \}}_{i} = 1$$

In other words, a sum of k importance levels {g (e, e′)}ᵢ calculated by the importance level calculation model g is 1.

The following description will discuss a specific example of a process carried out by the importance level calculation section 131A for calculating the importance level gᵢ. First, the importance level calculation section 131A uses a language model to transform, into a vector, a character string of each of attribute values of the first record e and the second record e′. Specifically, for example, the importance level calculation section 131A uses a function serialize (e, e′) for transforming the record pair (e, e′) into a character string to transform the record pair (e=(product name: potato chips, price: 198), e′=(product name: potechi, evaluation: 5)) into a character string “[CLS][COL]product name[VAL]potato chips[COL]price[VAL]198 [SEP][COL] product name[VAL]potechi[COL]evaluation[VAL]5 [SEP]”. Note here that [CLS], [COL], [VAL], and [SEP] are symbols representing a start of a sentence, an attribute name, an attribute value, and a separation of records, respectively.

Further, the importance level calculation section 131A uses a language model (e.g., BERT) to transform a generated character string into a vector. Subsequently, by applying concatenation, summation, deep learning, etc. to the vector obtained by the language model, the importance level calculation section 131A transforms the vector into a new L-dimensional vector z.

Further, the importance level calculation section 131A calculates the k importance levels {g (e, e′)}ᵢ by inputting, into a k-class classifier, the L-dimensional vector z obtained by transformation. For the k-class classifier, for example, a technique(s) such as a linear classifier and/or deep learning is/are used. For the k-class classifier, for example, a technique disclosed in a document “Robert A. Jacobs, Michael Jordan, Geoffrey Hinton: Adaptive Mixtures of Local Experts, Neural Computation 3, 79-87 (1991)” or a technique disclosed in a document “Noam Shazeer, Quoc Le, Geoffrey Hinton: Jeffrey Dean: OUTRAGEOUSLY LARGE NEURAL NETWORKS: THE SPARSELY-GATED MIXTURE-OF-EXPERTS LAYER, ICLR 2017” may be used.

For example, in i=1, . . . , k, for an L-dimensional vector wᵢ, an importance level {g (e, e′)}ᵢ, which is an i-dimensional output of a linear softmax function, is calculated by the following expression:

$$exp ( {w}_{i} \hat{} T \cdot z ) / ( exp ( {w}_{1} \hat{} T \cdot z ) + exp ( {w}_{2} \hat{} T \cdot z ) + … + exp ( {w}_{k} \hat{} T \cdot z ) )$$

Note here that the L-dimensional vector wᵢ is an example of a trainable parameter w of the importance level calculation model g. Note also that “wᵢ\hat{φ}T·z” is an inner product of the L-dimensional vector wᵢ and the L-dimensional vector z.

### (Step S106)

In step S106, the prediction section 13 uses similarities sᵢ calculated by the similarity calculation section 12 and the record pair (e, e′) to predict identity between the record pair (e, e′). For example, the prediction section 13 uses the k similarities sᵢ to calculate a similarity between the records included in the record pair (e, e′). In a case where the calculated similarity is higher than a threshold q (e.g., q=0.5), the prediction section 13 predicts that the record e and the record e′ are identical. In a case where the calculated probability is not more than the threshold q, the prediction section 13 predicts that the calculated probability the record e and the record e′ are not identical.

A probability calculated by the prediction section 13 represents a result of integrating and predicting the k similarities sᵢ for the record pair (e, e′), and is, for example, a numerical value of 0 to 1. In the present example embodiment, the prediction section 13 calculates the probability by a probability function h to which the record pair (e, e′) and the similarities sᵢ are input. For example, the probability function h is represented by the following equation (Mathematical Expression 1) with use of the k similarities sᵢ=φᵢ (e, e′).

$$( Mathematical Expression 1 )$$

$$h ( e , {e}^{′} \vert {\{ {ϕ}_{i} \}}_{i = 1}^{k} ) = {\sum }_{i = 1}^{k} {\{ g ( e , {e}^{′} ) \}}_{i} {ϕ}_{i} ( e , {e}^{′} )$$

In the above-described (Mathematical Expression 1), the importance level {g (e, e′)}ᵢ is an importance level calculated by the importance level calculation section 131A, and a similarity sᵢ=φᵢ (e, e′) is a similarity calculated for the record pair (e, e′) by the similarity function φᵢ. In a case where (Mathematical Expression 1) is used, in other words, the prediction section 13 carries out identity prediction with use of a linear sum regarding the plurality of similarities sᵢ, the linear sum using, as a weighting factor, the importance level {g (e, e′)}ᵢ regarding each of the plurality of similarities.

In the present example embodiment, the importance level {g (e, e′)}ᵢ can vary from record pair to record pair even in a case where the k similarities sᵢ calculated for each of the plurality of different record pairs (e, e′) are identical. In other words, not only the similarities sᵢ but also the importance level gᵢ determined by a record pair is reflected in the prediction result from the prediction section 13. A method in which the prediction section 13 predicts identity thus can vary from record pair to record pair.

### (Step S107)

In step S107, the output section 14 outputs the prediction result from the prediction section 13. For example, the output section 14 stores the prediction result in the storage section 20A.

### (Step S108)

In step S108, the prediction section 13 determines whether identity prediction has been carried out with respect to all the record pairs (e, e′) to be subjected to prediction. In a case where a prediction process has been completed for all the record pairs (e, e′) to be subjected to prediction (YES in step S108), the prediction section 13 proceeds to the process in step S109. In contrast, in a case where there remain(s) a record pair(s) (e, e′) to be subjected to prediction (NO in step S108), the prediction section 13 returns to the process in step S103 and carries out identity prediction with respect to a subsequent record pair (e, e′). That is, the information processing apparatus 1A carries out steps S103 to S107 with respect to all of the record pairs (e, e′) to be subjected to prediction.

### (Step S109)

In step S109, the integration section 15A generates integrated data from the first data and the second data with reference to the prediction result output by the output section 14. For example, the integration section 15A includes, in the integrated data, a record obtained by integrating records that are included in a record pair and that have been predicted by the prediction section 13 to be identical.

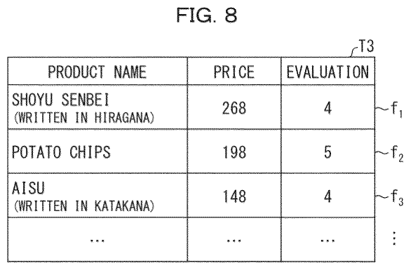

FIG. 8 is a diagram illustrating a table T3 that is an example of integrated data. The table T3 includes a plurality of records f₁, f₂, . . . . The record f₁ is a record obtained by integrating the first record e₁ and the second record e′₂ that are illustrated in FIG. 6. The record f₂ is a record obtained by integrating the first record e₂ and the second record e′₃ that are illustrated in FIG. 6. The record f₃ is a record obtained by integrating the first record e₃ and the second record e′₁ that are illustrated in FIG. 6.

### EXAMPLES

Next, the following description will discuss a specific example of the present example embodiment. In this example, similarity functions φ₁ to φ₃ are used as a similarity function {φᵢ}. The similarity function φ₁ is a function for calculating a Jaccard coefficient of a product name of a record pair. The similarity function φ₂ is a function for, in a case where a product name of a record pair is written in hiragana, transforming the hiragana into katakana, and then calculating a Jaccard coefficient. The similarity function φ₃ is a function for calculating a similarity by the method disclosed in the above-described Non-patent Literature 2. Note here that the similarity function φ₃ has a trainable parameter θ₃.

### (Step S101)

In step S101 of FIG. 7, the acquisition section 11 acquires test data Dₜₑₛₜ={(product name: shoyu senbei [soy sauce-flavored rice cracker] (written in hiragana), price: 268), (product name: shoyu senbei (written in katakana), evaluation: 4), . . . , ((product name: yomogi dango [mugwort dampling], price: 190), (product name: mitarashi dango [soy-glazed dumpling], evaluation: 3))}, which is a set of record pairs between which identity is unknown.

### (Steps S102 to S104)

The similarity calculation section 12 calculates a similarity S=(s₁, s₂, s₃). Note here that the similarity calculation section 12 reads a parameter θ₃ from the storage section 20A, and uses the read parameter θ₃ to calculate the similarity s₃. Specifically, the similarity calculation section 12 the similarity S=(φ₁ (e, e′), φ₂ (e, e′), φ₃ (e, e′))\hat{ }T=(0, 1, 0.7)\hat{ }T of a record pair {e=(product name: shoyu senbei (written in hiragana), price: 268), e′=(product name: shoyu senbei (written in katakana), evaluation: 4)} of the test data Dₜₑₛₜ.

### (Step S105)

The prediction section 13 uses the function serialize (e, e′) for concatenating an attribute name and an attribute value of the record pair (e, e′) to create a character string “[CLS][COL]product name[VAL]shoyu senbei (written in hiragana)[COL]price[VAL]268[SEP][COL]product name[VAL]shoyu senbei (written in katakana)[COL]evaluation[VAL]4[SEP]”. Further, the prediction section 13 uses BERT, which is a pretrained language model, to obtain an L-dimensional vector v that is a vector representation of the character string. Furthermore, the prediction section 13 uses a linear softmax function to calculate, for i=1, 2, 3, the importance level gᵢ, which is a weight assigned to the similarity function φᵢ, as follows:

$${g}_{i} = e \hat{} ( {w}_{1} \hat{} T \cdot v ) / ( {e}^{∧} ( {w}_{1} \hat{} T \cdot v ) + {e}^{∧} ( {w}_{2} \hat{} T \cdot v ) + {e}^{∧} ( {w}_{3} \hat{} T \cdot v ) ) ,$$

so that (g₁, g₂, g₃)=(0.1, 0.6, 0.3) is obtained. Note here that w₁, w₂, and w₃ are float-vectors and are examples of the trainable parameter w of the importance level calculation model g.

### (Step S106)

In step S106, the prediction section 13 calculates, as a probability, a sum obtained by multiplying, by the importance level ᵢ, the similarity S calculated by the similarity calculation section 12. Since the similarity S=(0, 1, 0.7)\hat{ }T and the importance level (g₁, g₂, g₃)=(0.1, 0.6, 0.3), the following equation is satisfied:

$$h ( e , {e}^{′} ) = 0.1 \times 0 + 0.6 \times 1 + 0.3 \times 0 \text{.7} = 0.81$$

Since the calculated value “0.81” is greater than a predetermined threshold q=0.5, the prediction section 13 predicts that the record e and the record e′ which are included in the record pair (e, e′) are identical.

### (Step S107)

In step S107, the output section 14 outputs a prediction result for identity between the record pair (e, e′). The above identity prediction and output are applied to all record pairs of the test data Dₜₑₛₜ.

### <Effect of Information Processing Apparatus 1A>

As described above, in the information processing apparatus 1A according to the present example embodiment, a configuration is employed such that the importance level gᵢ is calculated with reference to the record pair (e, e′), and the calculated importance level gᵢ is used to carry out identity prediction with respect to the record pair. Thus, the information processing apparatus 1A according to the present example embodiment brings about, in addition to the effect brought about by the information processing apparatus 1 according to the first example embodiment, an effect of making it possible to carry out identity prediction in which the importance level gᵢ calculated with use of the record pair (e, e′) is taken into account, and to more suitably predict identity between the record pair (e, e′).

### <Variation>

In the above-described example embodiment, the acquisition section 11 may further acquire auxiliary data u, and the prediction section 13 may refer to the record pair (e, e′), the plurality of similarities sᵢ, and the auxiliary data u, and use the importance level gᵢ determined in accordance with the record pair (e, e′) and the auxiliary data u to carry out identity prediction with respect to the record pair (e, e′).

The auxiliary data u includes, for example, information indicating a name of a record, a feature value of the record, and/or a result of classification of the record (confectionery, a person's name, etc.). Note here that the auxiliary data u may include, for example, information pertaining to the record, the information being obtained from external data such as Wikipedia (registered trademark). Note also that the auxiliary data u may include, for example, the number of training data used in training of (i) the parameter θ of the similarity function φᵢ and/or (ii) the parameter w of the importance level calculation model g. Note, however, that the auxiliary data u is not limited to the above-described example, but may include other information. The auxiliary data u is, for example, a one-hot vector representing discrete information.

In this case, in addition to the record pair (e, e′), the auxiliary data u is input to the importance level calculation model g. For example, the auxiliary data u, which is a vector, is concatenated to the above-described L-dimensional vector z, and the concatenated vector and the parameter w are used to calculate the importance level gᵢ.

In the present variation, the prediction section 13 refers to the record pair (e, e′), the plurality of similarities sᵢ, and the auxiliary data u, and uses the importance level gᵢ determined in accordance with the record pair (e, e′) and the auxiliary data u to carry out identity prediction with respect to the record pair (e, e′). This enables the prediction section 13 to predict identity between the record pair (e, e′) with higher accuracy.

### Third Example Embodiment

The following description will discuss a third example embodiment of the present invention in detail with reference to the drawings. Note that members having functions identical to those of the respective members described in the first and second example embodiments are given respective identical reference numerals, and a description of those members is not repeated.

### <Configuration of Information Processing Apparatus 1B>

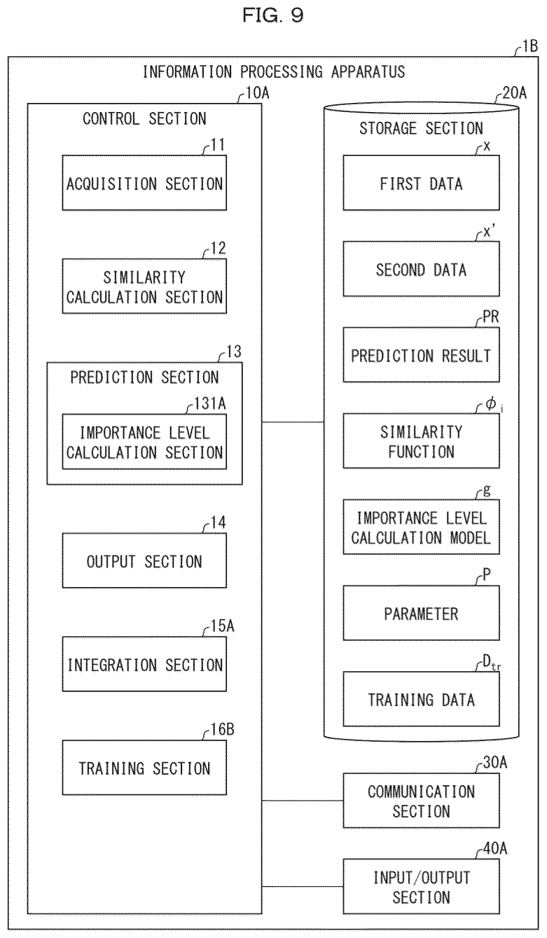

FIG. 9 is a block diagram illustrating a configuration of an information processing apparatus 1B according to the present example embodiment. A control section 10A of the information processing apparatus 1B includes a training section 16B in addition to an acquisition section 11, a similarity calculation section 12, a prediction section 13, an output section 14, and an integration section 15A.

The acquisition section 11 according to the present example embodiment further acquires training data Dₜᵣ including a plurality of sets of a record pair (eⱼ, e′ⱼ) and a label yⱼ regarding identity between the record pair (eⱼ, e′ⱼ). The training data Dₜᵣ is used to train the above-described parameter P. The training data Dₜᵣ is, for example, represented by the following equation:

$${𝒟}_{tr} {\{ ( {e}_{j} , {e}_{j}^{′} , {y}_{j} ) \}}_{j = 1}^{n}$$

where n is a total number of record pairs (eⱼ, e′ⱼ). The label yⱼ is, for example, “O” or “1”. “1” indicates that a first record ej and a second record e′ⱼ are identical, and “0” indicates that the first record eⱼ and the second record e′ⱼ are not identical.

The training section 16B generates, with reference to the training data, at least one parameter P selected from the group consisting of (i) one or more parameters θᵢ that are possessed by each of a plurality of similarity functions φᵢ which are used by the similarity calculation section 12 to calculate a similarity sᵢ, and (ii) one or more parameters w that are possessed by an importance level calculation model g which is used by an importance level calculation section 131A to calculate an importance level. The training section 16B is an example of a “parameter generation means” according to the present specification.

### <Flow of Information Processing Method S2B>

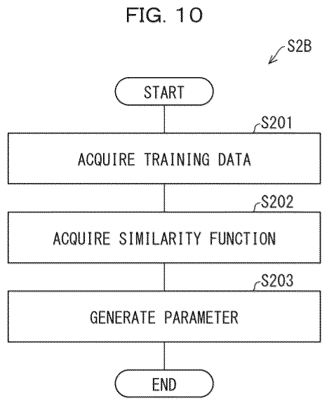

FIG. 10 is a flowchart showing a flow of an information processing method S2B that is an example of an information processing method carried out by the information processing apparatus 1B. Note that some of steps may be carried out in parallel or in a different order. Note also that a description of the content already described is not repeated.

### (Steps S201 and S202)

In step S201, the acquisition section 11 acquires training data Dₜᵣ. The training data Dₜᵣ is input by, for example, a user of the information processing apparatus 1B. In step S202, the acquisition section 11 acquires the plurality of similarity functions φᵢ. The similarity functions φᵢ are input by, for example, the user of the information processing apparatus 1B.

### (Step S203)

In step S203, the training section 16B uses the training data Dₜᵣ to train at least one of a parameter θᵢ and a parameter w. Note here that the parameter θᵢ is a set of parameters possessed by a similarity function φᵢ. Note also that the parameter w is a set of parameters possessed by the importance level calculation model g.

For example, the training section 16B uses an objective function L to optimize the parameter θᵢ and the parameter w. Such optimization is, for example, expressed as follows:

$${min}_{w , {\{ {θ}_{i} \}}_{i = 1}^{k}} \frac{1}{n} {\sum }_{j = 1}^{n} l ( {h}_{w} ( {e}_{j} , {e}_{j}^{′} \vert {\{ {ϕ}_{i , {θ}_{i}} \}}_{i = 1}^{k} ) , {y}_{j} ) + αΩ ( w , {\{ {θ}_{i} \}}_{i = 1}^{k} )$$

where an evaluation index 1 is expressed as follows:

$$l : [ 0 , 1 ] \times \{ 0 , 1 \} \to [ 0 , ∞ ]$$

That is, the evaluation index 1 is a loss function for outputting a value of not less than 0 by using, as an input, the following:
a probability with which records included in the record pair (eⱼ, e′ⱼ) of the training data Dₜᵣ are identical (an output of a probability function h_{w}); and
the label yⱼ of “0” or “1”.

The evaluation index 1 may be, for example, a cross entropy loss.

In the objective function L, a is a non-negative hyperparameter. The hyperparameter a may be determined by, for example, the user of the information processing apparatus 1B, or may be a value automatically determined with use of a set of a record pairs between which identity is known and which are separate from those of the training data Dₜᵣ. Ω is a regularization term for the parameter, and an L2 norm may be used. In the above expression, only the parameter w may be optimized with the parameter θᵢ fixed.

The training section 16B stores, in the storage section 20A, the parameter w and the parameter θᵢ that have been generated. The parameter w and the parameter θᵢ that have been generated by the training section 16B are used in a process carried out by the similarity calculation section 12 for calculating the similarity sᵢ and/or an identity prediction process carried out by the prediction section 13.

### Examples

Next, the following description will discuss a specific example of the present example embodiment. For example, for the first record e₁=(product name: potato chips, price: 198) and the first record e₂=(product name: aisu (written in katakana), price: 148) of the table T1, and the second record e′₁=(product name: potechi, evaluation: 5) and the second record e′₂=(product name: aisu (written in hiragana), evaluation: 4) of the table T2, the training data Dₜᵣ is represented by the following equation:

$${D}_{tr} = \{ ( {e}_{1} , {e}_{1}^{′} , 1 ) , ( {e}_{2} , {e}_{2}^{′} , 1 ) , ( {e}_{1} , {e}_{2}^{′} , 0 ) , ( {e}_{2} , {e}_{1}^{′} , 0 ) \}$$

Further, similarity functions φ₁ to φ₃ are used as a similarity function {φᵢ}. The similarity functions φ₁ to φ₃ are similar to the similarity functions φ₁ to φ₃ shown in Examples of the above-described first example embodiment. The similarity function φ₃ has a trainable parameter θ₃.

In step S201, the acquisition section 11 acquires the training data Dₜᵣ. In step S203, the training section 16B uses a stochastic gradient descent to optimize the parameter w of the importance level calculation model g and the parameter θᵢ of the similarity function φᵢ on the basis of a cross entropy loss so that identity prediction carried out by the prediction section 13 with respect to the record pair (eⱼ, e′ⱼ) of the training data Dₜᵣ will frequently come true. The parameter w and the parameter θᵢ that have been optimized are stored in the storage section 20A.

### <Effect of Information Processing Apparatus 1B>

As described above, in the information processing apparatus 1B according to the present example embodiment, a configuration is employed such that at least one parameter selected from the group consisting of the parameter w possessed by the importance level calculation model g and the parameter θᵢ possessed by the similarity function φᵢ is generated with reference to the training data Dₜᵣ. Thus, the information processing apparatus 1B according to the present example embodiment brings about not only the effect brought about by the information processing apparatus 1 according to the first example embodiment but also an effect of making it possible to generate a parameter that makes it possible to more suitably predict identity between a record pair.

### <Variation>

In the above-described example embodiment, the training data Dₜᵣ may include auxiliary data u. In this case, the training data Dₜᵣ is, for example, represented by the following equation:

$${𝒟}_{tr} {\{ ( {e}_{j} , {e}_{j}^{′} , {u}_{j} , {y}_{j} ) \}}_{j = 1}^{n}$$

The training section 16B uses the training data Dₜᵣ including the auxiliary data u to optimize the parameter w and the parameter θᵢ.

### Fourth Example Embodiment

The following description will discuss a fourth example embodiment of the present invention in detail with reference to the drawings. Note that members having functions identical to those of the respective members described in the first to third example embodiments are given respective identical reference numerals, and a description of those members is not repeated.

### <Configuration of Information Processing Apparatus 1C>

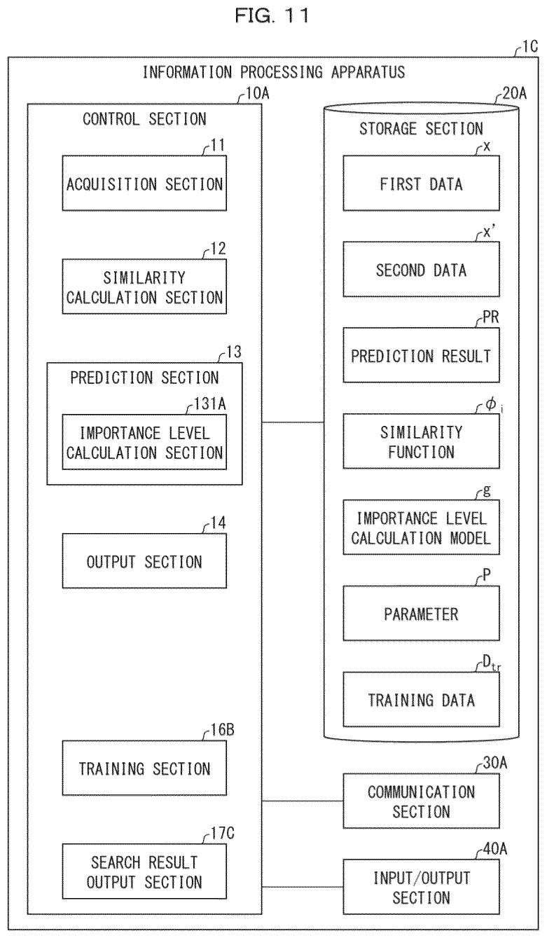

FIG. 11 is a block diagram illustrating a configuration of an information processing apparatus 1C according to the present example embodiment. A control section 10A of the information processing apparatus 1C includes a search result output section 17C in addition to an acquisition section 11, a similarity calculation section 12, a prediction section 13, an output section 14, and a training section 16B.

The acquisition section 11 according to the present example embodiment acquires, as a first record e included in a record pair (e, e′), input data from a user. The input data from the user is input by, for example, an input apparatus(es) (e.g., a keyboard, a mouse, and/or the like) connected to an input/output section 40A.

Further, the acquisition section 11 acquires, as a second record e′ included in the record pair (e, e′), one of a plurality of records included in target data. The target data is data serving as a search target, and includes, for example, one or more tables.

The prediction section 13 carries out identity prediction with respect to a record pair of the first record e and each of the plurality of records included in the target data. The search result output section 17C outputs, with reference to each prediction result PR output by the output section 14, a search result which is based on the input data and in which the target data is a search target. For example, the search result output section 17C outputs the search result to an output apparatus(es) (a display, a printer, and/or the like) connected to the input/output section 40A. Alternatively, the search result output section 17C may output the search result by transmitting the search result to another apparatus connected via the communication section 30A. Further alternatively, the search result output section 17C may output the search result by storing the search result in the storage section 20A or an external storage apparatus.

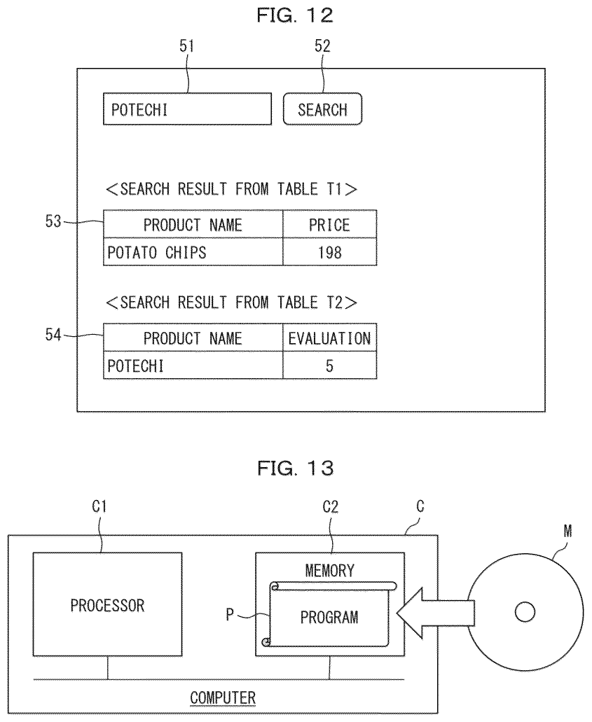

FIG. 12 is a diagram illustrating a specific example of a screen display output by the search result output section 17C. In the example of FIG. 12, the input data is a character string that is input by a user to a text box 51, and the target data is the table T1 and the table T2 that are illustrated in FIG. 6 in the above-described first example embodiment. The prediction section 13 carries out identity prediction with respect to a record pair of (i) the first record e that is the input data from the user and (ii) each of records included in the table T1 and records e′ included in the table T2. Since an identity prediction process carried out by the prediction section 13 has been described in the above-described second example embodiment, a description thereof is not repeated.

In the example of FIG. 12, the search result output section 17C refers to the prediction result PR from the prediction section 13, and outputs a search result 53 and a search result 54 that are based on the input data. The search result 53 is a search result that has been retrieved from the table T1 with a character string “potechi” used as the input data. The search result 54 is a search result retrieved from the table T2 with the character string “potechi” used as the input data.

### <Effect of Information Processing Apparatus 1C>

As described above, in the information processing apparatus 1C according to the present example embodiment, a configuration is employed such that a search result which is based on the input data and in which the target data is a search target is output with reference to each prediction result output by the output section 14. Thus, the information processing apparatus 1C according to the present example embodiment brings about, in addition to the effect brought about by the information processing apparatus 1 according to the first example embodiment, an effect of making it possible to more suitably carry out retrieval from the target data based on the input data.

The information processing apparatus 1C can also be described as below.

An information processing apparatus including:
an acquisition means that acquires, as a record pair, input data from a user and one of a plurality of records included in target data;
a similarity calculation means that uses a plurality of similarity functions to calculate a plurality of similarities for the record pair;
a prediction means that subjects a record pair of the input data and each of the plurality of records included in the target data to identity prediction with reference to the record pair and the plurality of similarities and with use of an importance level determined in accordance with the record pair; and
an output means that outputs, with reference to a prediction result from the prediction means, a search result which is based on the input data and in which the target data is a search target.

### Software Implementation Example

A part or all of the functions of each of the information processing apparatuses 1, 1A, 1B, 1C, and 2 (hereinafter, referred to as “information processing apparatus 1, etc.”) may be realized by hardware such as an integrated circuit (IC chip) or may be alternatively realized by software.

In the latter case, the information processing apparatus 1, etc. are each realized by, for example, a computer that executes instructions of a program that is software realizing the functions. FIG. 13 illustrates an example of such a computer (hereinafter, referred to as “computer C”). The computer C includes at least one processor C1 and at least one memory C2. In the memory C2, a program P for causing the computer C to operate as each of the information processing apparatus 1, etc. is recorded. In the computer C, the functions of each of the information processing apparatus 1, etc. are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An information processing apparatus including:
an acquisition means that acquires a record pair;
a similarity calculation means that uses a plurality of similarity functions to calculate a plurality of similarities for the record pair;
a prediction means that refers to the record pair and the plurality of similarities and that uses an importance level determined in accordance with the record pair to carry out identity prediction with respect to the record pair; and
an output means that outputs a prediction result from the prediction means.

The above configuration makes it possible to more suitably predict identity between the record pair.

### (Supplementary Note 2)

The information processing apparatus according to Supplementary note 1, wherein
the acquisition means further acquires auxiliary data, and
the prediction means refers to the record pair, the plurality of similarities, and the auxiliary data, and uses an importance level determined in accordance with the record pair and the auxiliary data to carry out identity prediction with respect to the record pair.

The above configuration allows the importance level to be information in which not only the content of the record pair but also the content of the auxiliary data is reflected. Identity between the record pair can be predicted with higher accuracy by using such an importance level to predict identity between the record pair.

### (Supplementary Note 3)

The information processing apparatus according to Supplementary note 1 or 2, wherein
the prediction includes an importance level calculation means that calculates the importance level with reference to the record pair.

According to the above configuration, identity between the record pair can be predicted with higher accuracy by using the importance level calculated with reference to the record pair to carry out identity prediction with respect to the record pair.

### (Supplementary Note 4)

The information processing apparatus according to Supplementary note 3, wherein
the importance level calculation means calculates the importance level regarding each of the plurality of similarities, and
the prediction means carries out the identity prediction with use of a linear sum regarding the plurality of similarities, the linear sum using, as a weighting factor, the importance level regarding each of the plurality of similarities.

According to the above configuration, identity between the record pair can be predicted with higher accuracy by carrying out identity prediction with use of a linear sum regarding the similarities, the linear sum using the importance level as a weighting factor.

### (Supplementary Note 5)

The information processing apparatus according to Supplementary note 3 or 4, wherein
the acquisition means further acquires training data including a plurality of sets of the record pair and a label regarding identity between the record pair,
the information processing apparatus
further including a parameter generation means that generates, with reference to the training data, at least one parameter selected from the group consisting of
   one or more parameters that are possessed by each of the plurality of similarity functions which are used by the similarity calculation means to calculate the similarities, and
   one or more parameters that are possessed by an importance level calculation model which is used by the importance level calculation means to calculate the importance level.

According to the above configuration, identity between the record pair can be more suitably predicted by using the parameter generated with reference to the training data.

### (Supplementary Note 6)

The information processing apparatus according to any one of Supplementary notes 1 to 5, wherein
the acquisition means acquires first data including a first record included in the record pair and second data including a second record included in the record pair,
the information processing apparatus further including an integration means that refers to the prediction result output by the output means and that generates integrated data from the first data and the second data.

The above configuration makes it possible to more suitably integrate the first data and the second data.

### (Supplementary Note 7)

The information processing apparatus according to any one of Supplementary notes 1 to 5, wherein
the acquisition means
   acquires, as a first record included in the record pair, input data from a user, and
   acquires, as a second record included in the record pair, one of a plurality of records included in target data, and
the prediction means carries out the identity prediction with respect to a record pair of the first record and each of a plurality of records included in the target data,
the information processing apparatus further including a search result output means that outputs, with reference to each prediction result output by the output means, a search result which is based on the input data and in which the target data is a search target.

The above configuration makes it possible to more suitably carry out retrieval from the target data based on the input data.

### (Supplementary Note 8)

An information processing apparatus including:
an acquisition means that acquires training data including a plurality of sets of a record pair and a label regarding identity between the record pair; and
a parameter generation means that generates, with reference to the training data, at least one parameter selected from the group consisting of
   one or more parameters that are possessed by each of a plurality of similarity functions for calculating a plurality of similarities for a record pair to be subjected to prediction, and
   one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

The above configuration makes it possible to generate a parameter that makes it possible to more suitably predict identity between the record pair.

### (Supplementary Note 9)

An information processing method including:
acquiring a record pair;
using a plurality of similarity functions to calculate a plurality of similarities for the record pair;
referring to the record pair and the plurality of similarities, and using an importance level determined in accordance with the record pair to carry out identity prediction with respect to the record pair; and
outputting a prediction result obtained by the prediction means.

The above information processing method brings about an effect similar to that brought about by the above-described information processing apparatus.

### (Supplementary Note 10)

An information processing method including:
acquiring training data including a plurality of sets of a record pair and a label regarding identity between the record pair; and
generating, with reference to the training data, at least one parameter selected from the group consisting of
   one or more parameters that are possessed by each of a plurality of similarity functions for calculating a plurality of similarities for a record pair to be subjected to prediction, and
   one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

The above information processing method brings about an effect similar to that brought about by the above-described information processing apparatus.

### (Supplementary Note 11)

A method for producing a trained model, including:
acquiring training data including a plurality of sets of a record pair and a label regarding identity between the record pair; and
generating, with reference to the training data, at least one model selected from the group consisting of
   a plurality of similarity calculation models for calculating a plurality of similarities for a record pair to be subjected to prediction, and
   an importance level calculation model used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

The above configuration makes it possible to produce a model that makes it possible to more suitably predict identity between the record pair.

### (Supplementary Note 12)

A program for causing a computer to carry out:
an acquisition process for acquiring a record pair;
a similarity calculation process for using a plurality of similarity functions to calculate a plurality of similarities for the record pair;
a prediction process for referring to the record pair and the plurality of similarities, and using an importance level determined in accordance with the record pair to carry out identity prediction with respect to the record pair; and
an output process for outputting a prediction result obtained by the prediction process.

The above configuration brings about an effect similar to that brought about by the above-described information processing apparatus.

### (Supplementary Note 13)

A program for causing a computer to carry out:
an acquisition process for acquiring training data including a plurality of sets of a record pair and a label regarding identity between the record pair; and
a parameter generation process for generating, with reference to the training data, at least one parameter selected from the group consisting of
   one or more parameters that are possessed by each of a plurality of similarity functions for calculating a plurality of similarities for a record pair to be subjected to prediction, and
   one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

The above configuration brings about an effect similar to that brought about by the above-described information processing apparatus.

### [Additional Remark 3]

The whole or part of the example embodiments disclosed above further can also be expressed as follows.

An information processing apparatus including at least one processor, the at least one processor carrying out: an acquisition process for acquiring a record pair; a similarity calculation process for using a plurality of similarity functions to calculate a plurality of similarities for the record pair; a prediction process for referring to the record pair and the plurality of similarities, and using an importance level determined in accordance with the record pair to carry out identity prediction with respect to the record pair; and an output process for outputting a prediction result from the prediction means.

Note that the information processing apparatus may further include a memory, which may store a program for causing the at least one processor to carry out the acquisition process, the similarity calculation process, the prediction process, and the output process. The program may be stored in a non-transitory tangible computer-readable storage medium.

The whole or part of the example embodiments disclosed above further can also be expressed as follows.

An information processing apparatus including at least one processor, the at least one processor carrying out: an acquisition process for acquiring training data including a plurality of sets of a record pair and a label regarding identity between the record pair; and a parameter generation process for generating, with reference to the training data, at least one parameter selected from the group consisting of one or more parameters that are possessed by each of a plurality of similarity functions for calculating a plurality of similarities for a record pair to be subjected to prediction, and one or more parameters that are possessed by an importance level calculation model which is used by a prediction means to calculate an importance level determined in accordance with the record pair to be subjected to prediction, the prediction means referring to the record pair to be subjected to prediction and the plurality of similarities, and using the importance level to carry out identity prediction with respect to the record pair to be subjected to prediction.

Note that the information processing apparatus may further include a memory, which may store a program for causing the at least one processor to carry out the acquisition process and the parameter generation process. The program may be stored in a non-transitory tangible computer-readable storage medium.

### REFERENCE SIGNS LIST

1, 1A, 1B, 1C, 2 Information processing apparatus
10A Control section
11, 21 Acquisition section
12 Similarity calculation section
13 Prediction section
14 Output section
15A Integration section
16B Training section
17C Search result output section
20A Storage section
22 Parameter generation section
30A Communication section
40A Input/output section
131A Importance level calculation section
S1, S1A, S2, S2B Information processing method

What is claimed is:

1. A record pair identity output apparatus comprising at least one processor, the at least one processor carrying out:
an acquisition process for acquiring a record pair including a first record that is input data from a user and a second record that is one of a plurality of records included in target data;
a similarity calculation process for using a plurality of similarity functions to calculate a plurality of similarities for the record pair;
a prediction process for referring to the record pair and the plurality of similarities, and using an importance level determined in accordance with the record pair to carry out identity prediction with respect to the record pair of the first record and each of the plurality of records included in the target data;
an output process for outputting a prediction result in the prediction process; and
a search result output process for outputting, with reference to each prediction result output in the output process, a search result which is based on the input data and in which the target data is a search target.

2. The record pair identity output apparatus according to claim 1, wherein
in the acquisition process, the at least one processor further acquires auxiliary data, and
in the prediction process, the at least one processor refers to the record pair, the plurality of similarities, and the auxiliary data, and uses an importance level determined in accordance with the record pair and the auxiliary data to carry out identity prediction with respect to the record pair.

3. The record pair identity output apparatus according to claim 1, wherein
in the prediction process, the at least one processor carries out an importance level calculation process for calculating the importance level with reference to the record pair.

4. The record pair identity output apparatus according to claim 3, wherein
in the importance level calculation process, the at least one processor calculates the importance level regarding each of the plurality of similarities, and
in the prediction process, the at least one processor carries out the identity prediction with use of a linear sum regarding the plurality of similarities, the linear sum using, as a weighting factor, the importance level regarding each of the plurality of similarities.

5. The record pair identity output apparatus according to claim 3, wherein
in the acquisition process, the at least one processor further acquires training data including a plurality of sets of the record pair and a label regarding identity between the record pair, and
the at least one processor further carries out a parameter generation process for generating, with reference to the training data, at least one parameter selected from the group consisting of
one or more parameters that are possessed by each of the plurality of similarity functions which are used in the similarity calculation process to calculate the similarities, and
one or more parameters that are possessed by an importance level calculation model which is used in the importance level calculation process to calculate the importance level.

6. The record pair identity output apparatus according to claim 1, wherein
in the acquisition process, the at least one processor acquires first data including a first record included in the record pair and second data including a second record included in the record pair, and
the at least one processor carries out an integration process for referring to the prediction result output in the output process, and generating integrated data from the first data and the second data.

7. (canceled)

8. A parameter generation apparatus comprising at least one processor, the at least one processor carrying out:
an acquisition process for acquiring training data including a plurality of sets of a record pair and a label regarding identity between the record pair; and
a parameter generation process for generating, with reference to the training data, at least one parameter selected from the group consisting of
one or more parameters that are possessed by each of a plurality of similarity functions for calculating a plurality of similarities for a record pair to be subjected to prediction, and
one or more parameters that are possessed by an importance level calculation model which is used by a prediction apparatus to calculate an importance level determined in accordance with the record pair to be subjected to prediction, the prediction apparatus referring to the record pair to be subjected to prediction and the plurality of similarities, and using the importance level to carry out identity prediction with respect to the record pair to be subjected to prediction.

9. A record pair identity output method comprising:
acquiring a record pair including a first record that is input data from a user and a second record that is one of a plurality of records included in target data;
using a plurality of similarity functions to calculate a plurality of similarities for the record pair;
referring to the record pair and the plurality of similarities, and using an importance level determined in accordance with the record pair to carry out identity prediction with respect to the record pair of the first record and each of the plurality of records included in the target data;
outputting a prediction result obtained by the identity prediction carried out with respect to the record pair; and
outputting, with reference to each prediction result output in the outputting, a search result which is based on the input data and in which the target data is a search target.

10-11. (canceled)

12. A non-transitory computer-readable storage medium storing therein a program for causing a computer to function as a record pair identity output apparatus according to claim 1, the program causing the computer to carry out the acquisition process, the similarity calculation process, the prediction process, the output process, and the search result output process.

13. A non-transitory computer-readable storage medium storing therein a program for causing a computer to function as a parameter generation apparatus according to claim 8, the program causing the computer to carry out the acquisition process and the parameter generation process.
